(19) United States
(12) Patent Application Publication
(10) Pub. No.: US 2026/0169257 A1
(43) Pub. Date: Jun. 18, 2026

(54) HIGH-PRECISION DUAL-AXIS ROTARY MOTOR ARCHITECTURE

(71) Applicant: Xiamen Zhonghui Microelectronics Co., Ltd., Xiamen (CN)

(72) Inventors: Huihuang Xu, Xiamen (CN); CHAO-CHUN CHANG, Xiamen (CN)

(21) Appl. No.: 19/423,836

(22) Filed: Dec. 17, 2025

(30) Foreign Application Priority Data
Dec. 18, 2024 (CN) 202411869939.1

(51) Int. Cl. G02B 7/18; G03B 17/17; H02K 7/08

(52) U.S. Cl. CPC G02B 7/1805; G03B 17/17; H02K 7/08

(57) ABSTRACT

This disclosure relates to a high-precision dual-axis rotary motor architecture, including a base, a first prism holder, a first drive portion, a second prism holder, and a second drive portion. The first prism holder is rotatably connected to the second prism holder by a first bearing mechanism, and the second prism holder is rotatably connected to the base by a second bearing mechanism. According to this disclosure, a rotating structure of θx is disposed on an outer layer, and two second balls that are far apart are used to form a rotational axis, so that the precision and stability of rotation at θx can be improved; and a rotating structure of θz is disposed in an inner layer, which greatly reduces the influence caused by prism gravity, increases the movement stability of the holders, and also shortens a distance between two first balls, thus reducing motor size.

### TECHNICAL FIELD

This disclosure relates to the field of optical imaging, and in particular, to a high-precision dual-axis rotary motor architecture.

### Background of the Art

A periscope lens structure usually includes two parts, namely, a lens part and a prism part, where the prism part is disposed at the front end of a periscope part, an imaging chip is disposed at the rear end of the lens part, and light is reflected by the prism part and enters into the lens part.

Cameras of existing electronic devices have a more and more powerful shooting function. A conventional shooting lens can only capture close-range images (1-2 meters). To achieve clear shots of distant views (10-20 meters), the lens must have a telephoto or zoom function. However, such lenses often need a long travel distance to achieve zoom, which leads to a relatively long total length of the lens and a height of the lens exceeding the thickness of the electronic device, making it difficult to meet the requirements of lightening or thinning of mobile terminal devices. Therefore, a periscope design as shown in FIG. 1 is usually adopted, that is, an optical path is designed to lie flat and a prism is added to rotate the optical path by 90 degrees. In this case, it is necessary to perform fine adjustment with small angles of θx and θy on prism holders on the mechanism, to perform OIS hand vibration compensation, so that the whole optical system can lie flat to reduce the overall height, and cooperate with a focusing motor to achieve focusing or zooming in a Z-axis direction.

However, a traditional periscope optical system will produce eccentricity in a zero field of view spot position during optical image stabilization, which leads to decrease in resolution. In 2020, Huawei proposed a new optical system (CN115917401A) from θy to θz, as shown in FIG. 2, which can effectively improve the optical imaging quality, and the design of an optical motor needs to be changed accordingly.

In patent applications with patent application No. 202421877241.X and 202422832134.1, a new dual-axis rotational structure is disclosed. However, in this structure, an optical sensitivity of θx is higher, so a more stable structure is needed. A rotating structure of θz is limited by a prism structure, and a placement position of a rotational axis structure is limited. Due to the influence of the gravity of the prism, there is a high risk of overturning, and it is necessary to lengthen a length of the rotational axis structure, so as to increase the stability, which leads to increase in motor size.

### SUMMARY

To solve the above problems in the prior art, this disclosure provides a high-precision dual-axis rotary motor architecture.

To achieve the above purpose, the technical solution adopted by this disclosure includes:
A high-precision dual-axis rotary motor architecture, including:
   Abase;
a first prism holder for fixedly connecting to a prism, where the prism is used for adjusting light incident in a second direction to transmit in a third direction, and the third direction is perpendicular to the second direction;
a first drive portion for driving the first prism holder to rotate around the third direction relative to the base;
a second prism holder for supporting the first prism holder; and
a second drive portion for driving the second prism holder to rotate around a first direction relative to the base, where the first direction is perpendicular to the second direction and the third direction.

The first prism holder is rotatably connected to the second prism holder through a first bearing mechanism; and the second prism holder is rotatably connected to the base through a second bearing mechanism.

Further, the first drive portion includes a first coil and a first magnet that are oppositely disposed along the third direction; the first coil is disposed on the base; and the first magnet is disposed on the first prism holder.

Further, the second drive portion includes a second coil and a second magnet that are oppositely disposed along the second direction; the second coil is disposed on the base; and the second magnet is disposed on the second prism holder.

Further, the first bearing mechanism includes at least two first guide members that are disposed along the third direction; and the second bearing mechanism includes at least two second guide members that are disposed along the first direction.

Further, the first bearing mechanism includes two first guide members; the first guide members are first balls (Specifically, the ball bearings mentioned in this application text are all simply referred to as balls) ; a first positioning groove matched with one first ball and a first limiting groove matched with the other first ball are formed at the bottom of the first prism holder; the first positioning groove is one of a conical groove, a polygonal groove, a V-shaped groove, or a rectangular groove, so that the first balls can only rotate around a fixed point within the first positioning groove; the first limiting groove is a V-shaped groove, and a length direction of the V-shaped groove is parallel to the third direction; a first clamping groove matched with the first guide members is formed at the top of the second prism holder; and the first clamping groove is one of a conical groove, a polygonal groove, a V-shaped groove, or a rectangular groove, so that the first balls can only rotate around a fixed point within the first clamping groove.

Further, the second bearing mechanism includes two second guide members; the second guide members are second balls; a second positioning groove matched with one second ball and a second limiting groove matched with the other second ball are formed at the bottom of the second prism holder; the second positioning groove is one of a conical groove, a polygonal groove, a V-shaped groove, or a rectangular groove, so that the second balls can only rotate around a fixed point within the second positioning groove; the first limiting groove is a V-shaped groove, and a length direction of the V-shaped groove is parallel to the first direction; a second clamping groove matched with the second guide members is formed in the base; and the second clamping groove is one of a conical groove, a polygonal groove, a V-shaped groove, or a rectangular groove, so that the second balls can only rotate around a fixed point within the second clamping groove.

Further, the first bearing mechanism includes two first guide members, where one first guide member is a first ball, and the other first guide member is a cylindrical shaft with a length direction parallel to the third direction; and the second bearing mechanism includes two second guide members, where one second guide member is a second ball, and the other second guide member is a cylindrical shaft with a length direction parallel to the first direction.

Further, the first bearing mechanism includes two first guide members, where one first guide member is a semi-circular protrusion formed at the top of the second prism holder, and the other first guide member is a semi-cylindrical protrusion that is formed at the top of the second prism holder and has a length direction parallel to the third direction; and the second bearing mechanism includes two second guide members, where one second guide member is a semi-circular protrusion formed on the base, and the other second guide member is a semi-cylindrical protrusion that is formed on the base and has a length direction parallel to the first direction.

Further, the two first balls are disposed at intervals; a magnetic conducting sheet located between the two first balls is disposed on the second prism holder; and a reinforcing magnet matched with the magnetic conducting sheet is disposed at the bottom of the first prism holder.

This disclosure has the following beneficial effects: a rotating structure of θx is disposed on an outer layer, the two second balls are used to form a rotational axis, and a distance between the two second balls is relatively large, so that the precision and stability of rotation at θx can be improved; a rotating structure of θz is disposed in an inner layer, which greatly reduces the influence of prism gravity, and the bearing mechanism can also use internal spaces of the two holders to accommodate the guide members, which is beneficial to reducing the volume; and the built-in rotating structure of θz also increases the movement stability of the holders and shortens the distance between the two first balls, thus reducing motor size.

### BRIEF DESCRIPTION OF THE DRAWINGS

To describe the technical solutions in the embodiments of this disclosure more clearly, the following briefly describes the accompanying drawings required for describing the embodiments. It should be understood that the following accompanying drawings show merely some embodiments of this disclosure, and therefore should not be regarded as a limitation on the scope. Those of ordinary skill in the art may still derive other related accompanying drawings from these accompanying drawings without creative efforts.

FIG. 1 is a schematic diagram of a light path of a prism module in the prior art;

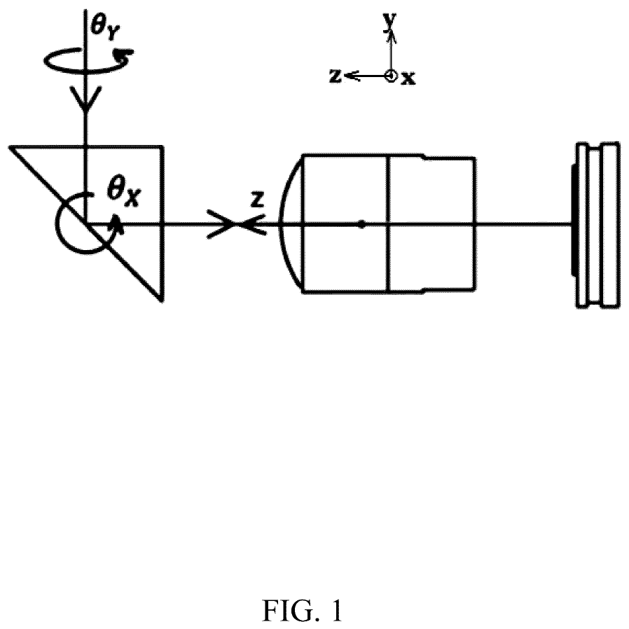

FIG. 2 is a schematic diagram of an improved light path of a prism module;

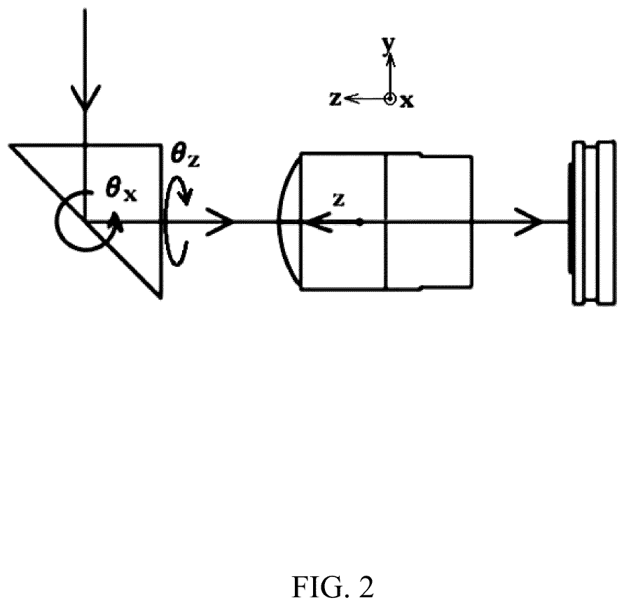

FIG. 3 is an exploded view of a structure according to this disclosure;

FIG. 4 is a bottom view of a first prism holder of this disclosure; and

FIG. 5 is a bottom view of a second prism holder of this disclosure.

Reference numerals in the accompanying drawings:

100: base; 101: accommodation space; 110: top cover; 111: light inlet hole; 200: first prism holder; 210: prism; 220: first bearing mechanism; 221: first ball; 222: first positioning groove; 223: first limiting groove; 224: first clamping groove; 225: reinforcing magnet; 226: magnetic conducting sheet; 300: first drive portion; 310: first coil; 320: first magnet; 400: second prism holder; 410: second bearing mechanism; 411: second ball; 412: second positioning groove; 413: second limiting groove; 414: second clamping groove; 500: second drive portion; 510: second coil; 520: second magnet; and 600: lens module.

### DETAILED DESCRIPTION OF THE EMBODIMENTS

To make the objectives, technical solutions, and advantages of the embodiments of this disclosure clearer, the following clearly and completely describes the technical solutions in the embodiments of this disclosure with reference to the accompanying drawings in the embodiments of this disclosure. Apparently, the described embodiments are some but not all of the embodiments of this disclosure. Based on the embodiments in this disclosure, all other embodiments obtained by those of ordinary skill in the art without making creative efforts shall fall within the protection scope of this disclosure. Therefore, the detailed description of the embodiments of this disclosure provided in the accompanying drawings is not intended to limit the scope of the claimed disclosure, but only to represent selected embodiments of this disclosure. Based on the embodiments in this disclosure, all other embodiments obtained by those of ordinary skill in the art without making creative efforts shall fall within the protection scope of this disclosure.

In the description of this disclosure, it should be noted that the orientations or positional relationships indicated by the terms “up”, “down”, “inner”, “outer”, “front end”, “rear end”, “both ends”, “one end”, “the other end”, etc. are based on those shown in the accompanying drawings, intended only for the convenience of describing this disclosure and for simplifying the description, and not intended to indicate or imply that the referred apparatus or element must be provided with a particular orientation or constructed and operated with a particular orientation, therefore not allowed to be construed as a limitation of this disclosure. Furthermore, the terms “first” and “second” are used for descriptive purposes only and should not be construed as indication or implication of relative importance.

In the description of this disclosure, it should be noted that, unless otherwise explicitly provided and limited, the terms “mounted”, “arranged”, and “connected” should be understood in a broad sense, e.g., “connected” may be a fixed connection, a detachable connection, or an integral connection; it may be a mechanical connection or an electrical connection; it may be a direct connection or an indirect connection through an intermediate medium; and it may be a connection between two elements. For a person of ordinary skill in the art, the specific meanings of the above terms in this disclosure may be understood based on specific circumstances.

### Embodiments

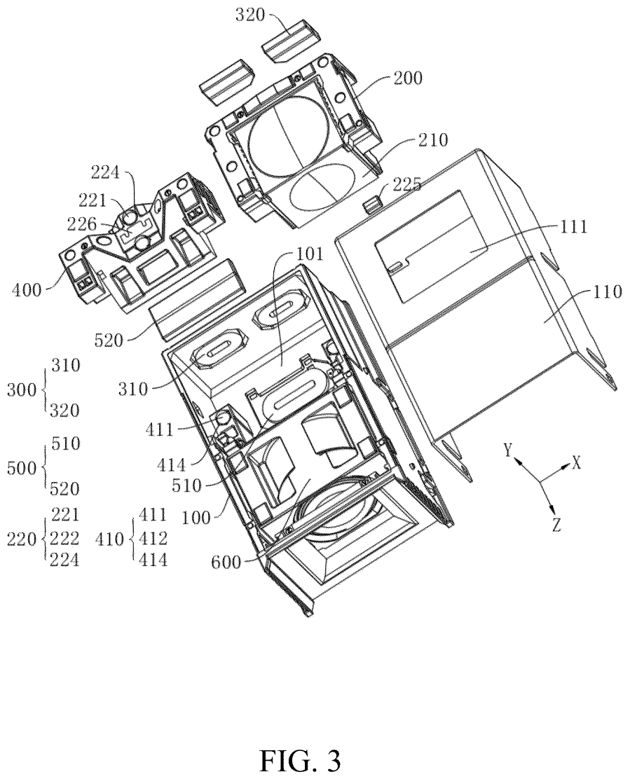

As shown in FIG. 3, a first direction is parallel to an X direction, a second direction is parallel to a Y direction, and a third direction is parallel to a Z direction.

For the convenience of description, the first direction can also be called the X direction, the second direction can also be called the Y direction, and the third direction can also be called the Z direction.

A high-precision dual-axis rotary motor architecture includes a base 100, a first prism holder 200, a first drive portion 300, a second prism holder 400, and a second drive portion 500. An accommodation space 101 is formed in the base 100 for placing the first prism holder 200 and the second prism holder 400 and allowing the first prism holder 200 and the second prism holder 400 to move. The first prism holder 200 is fixedly connected to a prism 210; the prism 210 is used to adjust the light incident in the Y direction to transmit in the Z direction; and the Z direction is usually also called an optical axis direction. The first drive portion 300 is used to drive the first prism holder 200 to rotate around the Z direction, and the second drive portion 500 is used to drive the second prism holder 400 to rotate around the X direction. The first prism holder 200 is positioned above the second prism holder 400, so when the second prism holder 400 rotates around the X direction, it can also drive the first prism holder 200 to rotate around the X direction, that is, the first prism holder 200 can rotate in the X and Z directions. Compared with the earlier solutions, in this disclosure, rotational axes of the first prism holder 200 and the second prism holder 400 are exchanged, and a highly sensitive rotating structure in the X direction is disposed on an outer layer, that is, the second prism holder 400 completes the rotation in the X direction, thereby increasing a spacing between rotating parts and contributing to improving the accuracy and stability of the rotation in the X direction; and a rotating structure of θx is disposed on the outer layer, that is, at the bottom of the second prism holder 400, which can effectively controls the uniform distribution of weight of a prism assembly, thus reducing the adverse effects caused by gravity torque. The prism assembly is mainly composed of the first prism holder 200, the prism 210, and the second prism holder 400. The second prism holder 400 is triangular when viewed from a side (the X direction), and the first prism holder 200 and the prism 210 are also triangular when viewed from the side (the X direction), that is, the prism assembly is rectangular when viewed from the side (X direction). When the rotating structure of θx is disposed on the outer layer, weights of both sides in the X direction are almost equal, the control difficulty when the second drive portion 500 is in driving is greatly reduced, and the response speed is also faster, thereby improving the rotating accuracy of θx. However, in the prior art, the rotating structure of θx is disposed between the first prism holder 200 and the second prism holder 400, so as to control the first prism holder 200 to perform rotation of θx. According to the above analysis, since the first prism holder 200 and the prism 210 are triangular when viewed from the side (the X direction), when the first prism holder 200 rotates in the X direction, it is obvious that the weight of the prism 210 is larger in a positive direction of a Z axis. When rotating in the X direction, a drive assembly needs to overcome the gravity torque, so as to drive the first prism holder 200 to rotate. However, with different rotation angles, the influence of the gravity torque of the prism 210 is always changing, which poses a huge challenge to a control manner, and the uneven distribution of weight also leads to the decrease of the control speed, which directly affects the rotation accuracy and response speed.

A rotating structure in the Z direction is built in, that is, the first prism holder 200 is responsible for rotating in the Z direction, which can ensure better support for the prism 210, reduce the risk of overturning, and make the whole holder movement more stable. In the prior art, the first prism holder 200 usually rotates around the X direction, but the weight of the prism 210 on the first prism holder 200 in the Z direction is uneven. Generally, the first prism holder 200 and the prism 210 are triangular when viewed from the side (the X direction), so there is a greater risk of overturning when rotating around the X direction. According to this disclosure, the rotational axis of the first prism holder 200 is set to the Z direction, so that the weight of the first prism holder 200 in the X direction is equal, that is, the weight on both sides of the Z axis is basically the same, thereby avoiding the problem of overturning, and greatly improving the rotation accuracy of the first prism holder 200 at θz.

The first drive portion 300 includes a first coil 310 and a first magnet 320 that are oppositely disposed along the Z direction; the first coil 310 is disposed on the base 100; and the first magnet 320 is disposed on the first prism holder 200.

The second drive portion 500 includes a second coil 510 and a second magnet 520 that are oppositely disposed along the Y direction; the second coil 510 is disposed on the base 100; and the second magnet 520 is disposed on the second prism holder 400.

In an embodiment, the first bearing mechanism 220 includes at least two first guide members that are disposed along the third direction, a central connecting line of the plurality of first guide members is parallel to the third direction, and the central connecting line of the plurality of first guide members is a rotational axis of the first prism holder 200; and the second bearing mechanism includes at least two second guide members that are disposed along the first direction, a central connecting line of the plurality of second guide members is parallel to the first direction, and the central connecting line of the plurality of second guide members is a rotational axis of the second prism holder 400.

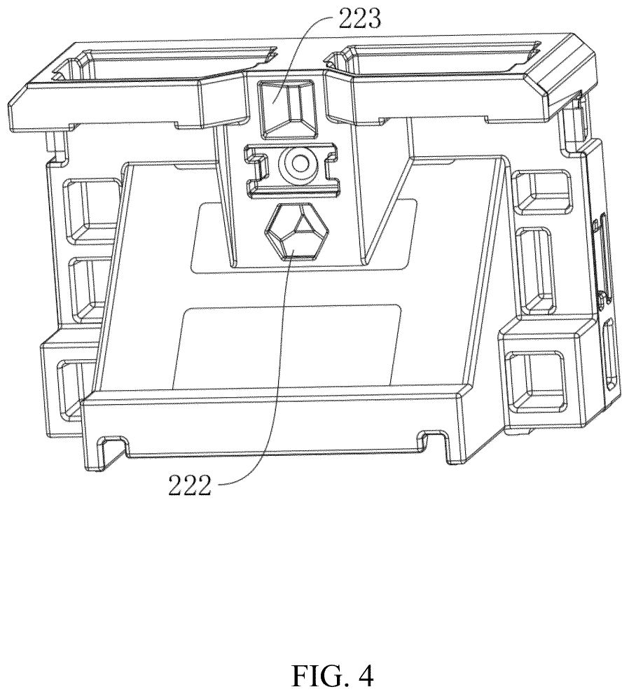

As shown in FIG. 3/FIG. 4, in an embodiment, the first bearing mechanism 220 includes two first guide members; the first guide members are first balls 221; a
first positioning groove 222 matched with one first ball 221 and a first limiting groove 223 matched with the other first ball 221 are formed at the bottom of the first prism holder 200; the first positioning groove 222 is one of a conical groove, a polygonal groove, a V-shaped groove, or a rectangular groove, so that the first balls 221 can only rotate around a fixed point within the first positioning groove 222. It can be understood that the first balls 221 only rotate around their own center in the first positioning groove 222, but cannot slide, thus ensuring that positions of the first balls 221 and the first positioning groove 222 are relatively fixed. The purpose of the first positioning groove 222 is to position and match with the first balls 221, so as to ensure an installation position of the first prism holder 200, reduce unnecessary movement, and only keep a required degree of freedom to improve the movement accuracy. In FIG. 4, the first positioning groove 222 shows a structure of a polygonal groove, which contains three inclined surfaces matched with the first balls 221, which is equivalent to a three-point contact, thus reducing a contact area and facilitating the activities of the first balls 221. When the first positioning groove 222 is a conical groove, the contact area with the first balls 221 is equivalent to a circular line contact; when the first positioning groove 222 is a V-shaped groove, both sides of a longitudinal direction of the V-shaped groove need to contact with the first balls 221, so as to avoid the movement of the first balls 221 in the longitudinal direction of the V-shaped groove; and when the first positioning groove 222 is a rectangular groove, four sides or four surfaces of the rectangular groove are all in contact with the first balls 221, so as to limit the movement of the first balls 221.

The first limiting groove 223 is a V-shaped groove, and a length direction of the V-shaped groove is parallel to the third direction; the first limiting groove 223 can facilitate the rapid installation of the first prism holder 200; and a first clamping groove 224 matched with the first guide members is formed at the top of the second prism holder 400, and the first clamping groove 224 is one of a conical groove, a polygonal groove, a V-shaped groove, or a rectangular groove, so that the first balls 221 can only rotate around a fixed point within the first clamping groove 224. Similarly, the purpose of the first clamping groove 224 is to ensure the installation position of the first balls 221, so that the first balls 221 can be clamped in a fixed position and can only rotate on its axis; the first clamping groove 224 is formed upwardly, which is convenient for the rapid installation of the first balls 221; and when the first balls 221 are matched with the first positioning groove 222, the installation and positioning of the first prism holder 200 can be quickly completed. The first limiting groove 223 is set as a V-shaped groove, a length direction of the V-shaped groove is parallel to the third direction, and a length of the V-shaped groove is greater than a diameter of the first balls 221, so that when the first prism holder 200 is installed, positioning and installation can be completed only by aligning one first ball 221, and the installation difficulty is reduced. In another embodiment, one of the first clamping grooves 224 can be set as a V-shaped groove that is formed opposite to the first limiting groove 223. When one of the first balls 221 is positioned, it can also ensure the installation accuracy of the first prism holder 200 and enable the first prism holder to rotate around the Z axis.

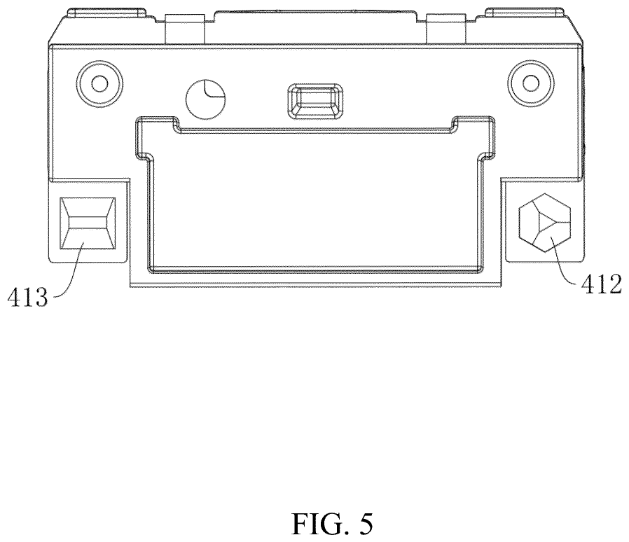

As shown in FIG. 3/FIG. 5, in an embodiment, the second bearing mechanism 410 includes second guide members; the second guide members are second balls 411; a second positioning groove 412 matched with one second ball 411 and a second limiting groove 413 matched with the other second ball 411 are formed at the bottom of the second prism holder 400; and the second positioning groove 412 is one of a conical groove, a polygonal groove, a V-shaped groove, or a rectangular groove, so that the second balls 411 can only rotate around a fixed point within the second positioning groove 412. A working principle of the second positioning groove 412 is the same as that of the first positioning groove 222. The second limiting groove 413 is a V-shaped groove, a length direction of the V-shaped groove is parallel to the first direction, and a length of the V-shaped groove is greater than a diameter of the second balls 411. A second clamping groove 414 matched with the second guide members is disposed in the base 100; and the second clamping groove 414 is one of a conical groove, a polygonal groove, a V-shaped groove, or a rectangular groove, so that the second balls 411 can only rotate around a fixed point within the second clamping groove 414. A working principle of the second clamping groove 414 is the same as that of the first clamping groove 224. The two second balls 411 are disposed on both sides of the second prism holder 400, and a distance between the second balls 411 is far, so that the accuracy and stability of rotation in the X direction can be improved.

In an embodiment, the first bearing mechanism 220 includes two first guide members, where one first guide member is a first ball 221, and the other first guide member is a cylindrical
shaft with a length direction parallel to the third direction; and the second bearing mechanism 410 includes two second guide members, where one second guide member is a second ball 411, and the other second guide member is a cylindrical shaft with a length direction parallel to the first direction. (not shown in the figure).

In an embodiment, the first bearing mechanism 220 includes two first guide members, where one first guide member is a semi-circular protrusion formed at the top of the second prism holder 400, and the other first guide member is a semi-cylindrical protrusion that is formed at the top of the second prism holder 400 and has a length direction parallel to the third direction; that is, the first guide members and the second prism holder 400 form an integral structure; and the second bearing mechanism 410 includes two second guide members, where one second guide member is a semi-circular protrusion formed on the base 100, and the other second guide member is a semi-cylindrical protrusion that is formed on the base 100 and has a length direction parallel to the first direction; that is, the second guide members and the base 100 form an integral structure. (not shown in the figure).

In an embodiment, the two first balls 221 are disposed at intervals; a magnetic conducting sheet 226 located between the two first balls 221 is disposed on the second prism holder 400; and a reinforcing magnet 225 matched with the magnetic conducting sheet 226 is disposed at the bottom of the first prism holder 200. The reinforcing magnet 225 and the magnetic conducting sheet 226 are coordinated to enable the first prism holder 200 to continuously and effectively abut on the two first balls 221, and to enhance the coordination stability between the first prism holder 200 and the second prism holder 400.

In an embodiment, when the high-precision dual-axis rotary motor architecture is used for a periscope camera module, a lens module 600 is also disposed in the accommodation space 101 of the base 100; a top cover 110 is sleeved on the top of the base 100 to form a complete periscope camera module; and the top cover 110 is provided with a light inlet hole 111 opposite to the prism 210. Light enters the prism 210 through the light inlet hole 111, and then enters the lens module 600 in the Z direction after being reflected by the prism 210.

The above-described embodiments are only embodiments of this disclosure and do not limit the patent protection scope of this disclosure. Any equivalent transformations based on the content of the specification and accompanying drawings of this disclosure, or direct or indirect application of the above-described embodiments in related technical fields are all included in the patent protection scope of this disclosure for the same reason.

1. A high-precision dual-axis rotary motor architecture, comprising:
a base (100);
a first prism holder (200) for fixedly connecting to a prism (210), wherein the prism (210) is used for adjusting light incident in a second direction to transmit in a third direction, and the third direction is perpendicular to the second direction;
a first drive portion (300) for driving the first prism holder (200) to rotate around the third direction relative to the base (100);
a second prism holder (400) for supporting the first prism holder (200); and
a second drive portion (500) for driving the second prism holder (400) to rotate around a first direction relative to the base (100), wherein the first direction is perpendicular to the second direction and the third direction;
the first prism holder (200) is rotatably connected to the second prism holder (400) through a first bearing mechanism (220); the second prism holder (400) is rotatably connected to the base (100) through a second bearing mechanism (410); and a rotational axis of the first prism holder (200) intersects with a rotational axis of the second prism holder (400) at a single point.

2. The high-precision dual-axis rotary motor architecture according to claim 1, wherein the first drive portion (300) comprises a first coil (310) and a first magnet (320) that are oppositely disposed along the third direction; the first coil (310) is disposed on the base (100); and the first magnet (320) is disposed on the first prism holder (200).

3. The high-precision dual-axis rotary motor architecture according to claim 1, wherein the second drive portion (500) comprises a second coil (510) and a second magnet (520) that are oppositely disposed along the second direction; the second coil (510) is disposed on the base (100); and the second magnet (520) is disposed on the second prism holder (400).

4. The high-precision dual-axis rotary motor architecture according to claim 1, wherein the first bearing mechanism (220) comprises at least two first guide members that are disposed along the third direction; and the second bearing mechanism (410) comprises at least two second guide members that are disposed along the first direction.

5. The high-precision dual-axis rotary motor architecture according to claim 4, wherein the first bearing mechanism (220) comprises two first guide members; the first guide members are first balls (221); a first positioning groove (222) matched with one first ball (221) and a first limiting groove (223) matched with the other first ball (221) are formed at the bottom of the first prism holder (200); the first positioning groove (222) is one of a conical groove, a polygonal groove, or a V-shaped groove, so that the first balls (221) can only rotate around a fixed point within the first positioning groove (222); the first limiting groove (223) is a V-shaped groove, and a length direction of the V-shaped groove is parallel to the third direction; a first clamping groove (224) matched with the first guide members is formed at the top of the second prism holder (400); and the first clamping groove (224) is one of a conical groove, a polygonal groove, or a V-shaped groove, so that the first balls (221) can only rotate around a fixed point within the first clamping groove (224).

6. The high-precision dual-axis rotary motor architecture according to claim 4, wherein the second bearing mechanism (410) comprises two second guide members; the second guide members are second balls (411); a second positioning groove (412) matched with one second ball (411) and a second limiting groove (413) matched with the other second ball (411) are formed at the bottom of the second prism holder (400); the second positioning groove (412) is one of a conical groove, a polygonal groove, or a V-shaped groove, so that the second balls (411) can only rotate around a fixed point within the second positioning groove (412); the first limiting groove (413) is a V-shaped groove, and a length direction of the V-shaped groove is parallel to the first direction; a second clamping groove (414) matched with the second guide members is formed in the base (100); and the second clamping groove (414) is one of a conical groove, a polygonal groove, or a V-shaped groove, so that the second balls (411) can only rotate around a fixed point within the second clamping groove (414).

7. The high-precision dual-axis rotary motor architecture according to claim 4, wherein the first bearing mechanism (220) comprises two first guide members, wherein one first guide member is a first ball (221), and the other first guide member is a cylindrical shaft with a length direction parallel to the third direction; and the second bearing mechanism (410) comprises two second guide members, wherein one second guide member is a second ball (411), and the other second guide member is a cylindrical shaft with a length direction parallel to the first direction.

8. The high-precision dual-axis rotary motor architecture according to claim 4, wherein the first bearing mechanism (220) comprises two first guide members, wherein one first guide member is a semi-circular protrusion formed at the top of the second prism holder (400), and the other first guide member is a semi-cylindrical protrusion that is formed at the top of the second prism holder (400) and has a length direction parallel to the third direction; and the second bearing mechanism (410) comprises two second guide members, wherein one second guide member is a semi-circular protrusion formed on the base (100), and the other second guide member is a semi-cylindrical protrusion that is formed on the base (100) and has a length direction parallel to the first direction.

9. The high-precision dual-axis rotary motor architecture according to claim 5, wherein the two first balls (221) are disposed at intervals; a magnetic conducting sheet (226) located between the two first balls (221) is disposed on the second prism holder (400); and a reinforcing magnet (225) matched with the magnetic conducting sheet (226) is disposed at the bottom of the first prism holder (200).
